(19) United States
(12) Patent Application Publication
(10) Pub. No.: US 2015/0170455 A1
(43) Pub. Date: Jun. 18, 2015

(54) System and Method for Scoring Points of Interest in a Parallel Reality Game

(71) Applicant: Google Inc., (US)

(72) Inventors: Ali Ajdari Rad, Adliswil (CH); Pascal Corpet, Gockhausen (CH); Ammar Ibrahim, Zurich (CH)

(73) Assignee: Google Inc., Mountain View, CA (US)

(21) Appl. No.: 13/860,095

(22) Filed: Apr. 10, 2013

(51) Int. Cl. G07F 17/32

(52) U.S. Cl. CPC G07F 17/323

(57) ABSTRACT

Systems and methods for assigning a score to a virtual point of interest included in a virtual world associated with a parallel reality game are provided. The virtual point of interest can parallel a real world point of interest. A computer-implemented method can include accessing a data source to obtain activity data concerning online activity associated with the real world point of interest. The method can also include determining a score for the virtual point of interest based on the activity data. The method can include modifying game data associated with the parallel reality game to assign the score to the virtual point of interest. Other exemplary aspects are directed to systems and devices for assigning a score to a virtual point of interest included in a parallel reality game.

### FIELD

The present disclosure relates generally to parallel reality gaming, and more particularly, to a system and method for determining and assigning scores to virtual points of interest in a parallel reality game.

### BACKGROUND

Modern games, such as games designed for a personal computer, a mobile device, or a portable or stationary gaming console, often take place in a virtual world. For example, some games may be set in a fantasy world or take place in a virtual world that contains few similarities to the real world. However, some individuals may not be interested in such games because their associated virtual worlds do not parallel real life. In this sense, some individuals may hesitate to play such games because they are not attracted to participating in a world that does not exist.

Parallel reality games offer an opportunity to play a game that is set in a virtual world that mimics, or parallels, the real world to varying degrees. For example, a parallel reality game can have a virtual world that parallels at least a portion of the geography of the real world. In this case, the game has a more natural feeling and is more engaging for individuals who prefer to focus on real-world activities or places. As such, parallel reality games can provide an opportunity for individuals who otherwise would not enjoy playing games to enjoy and participate in the parallel reality game.

A challenge presented by creating and providing parallel reality games is ensuring that the virtual world realistically parallels the real world. More particularly, ensuring that game players feel that the virtual world is naturally or innately connected to the real world can improve the game playing experience. For example, game players can be provided with a sense that game actions or game developments are reflective of real world events or real world activities and vice versa.

One response to such a challenge can be to incorporate real world data into the creation or maintenance of the virtual world associated with the parallel reality game. For example, a plurality of points of interest can exist in the real world. Therefore, a plurality of parallel virtual points of interest can be provided in the virtual world so that the virtual world more accurately parallels the real world. Thus, a game player is presented with familiar locations and points of interest, such as businesses, buildings, parks, or other points of interest, increasing the feeling that the virtual world is connected to the real world.

However, simply providing the parallel, virtual points of interest can leave the player feeling as though something is missing. In particular, the real world points of interest can have particular characteristics or attributes. For example, different real world points of interest may have different levels of importance or popularity within the game-playing community. Reflecting such real world attributes with respect to the virtual points of interest can improve the parallel reality game play experience.

Thus, systems and methods for scoring virtual points of interest in a parallel reality game are desirable.

### SUMMARY

Aspects and advantages of the invention will be set forth in part in the following description, or may be obvious from the description, or may be learned through practice of the invention.

One exemplary aspect is directed to a computer-implemented method of assigning a score to a virtual point of interest included in a virtual world associated with a parallel reality game. The virtual world can have a geography that parallels at least a portion of the real world and the virtual point of interest can parallel a real world point of interest. The method can include accessing a data source to obtain activity data concerning online activity associated with the real world point of interest. The method can also include determining a score for the virtual point of interest based on the activity data. The method can include modifying game data associated with the parallel reality game to assign the score to the virtual point of interest.

Other exemplary aspects are directed to systems, apparatus, non-transitory computer-readable media, and devices for determining and assigning a score to a virtual point of interest included in a parallel reality game.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts an exemplary scoring engine and associated signals according to an exemplary embodiment of the present disclosure;

FIG. 2 depicts an exemplary game interface according to an exemplary embodiment of the present disclosure;

FIG. 3 depicts an exemplary computer-based gaming system configured in accordance with an embodiment of the present disclosure;

FIG. 4 depicts a flow chart of an exemplary computer-implemented method for assigning a score to a virtual point of interest included in a virtual world associated with a parallel reality game according to an exemplary embodiment of the present disclosure; and

FIG. 5 depicts a flow chart of an exemplary computer-implemented method for assigning a score to a virtual point of interest included in a virtual world associated with a parallel reality game according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

### Overview

The present disclosure is generally directed to a scoring metric for determining and assigning a value or score to virtual points of interest in a parallel-reality game. The parallel reality game can include a virtual world that parallels at least a portion of the real world such that the virtual points of interest parallel real world points of interest. A scoring engine can implement the scoring metric to determine and assign the score to the virtual points of interest. The scoring engine can determine the score based on signals incorporated from web-based technology, social media platforms, and other suitable data sources such as a location database. The incorporated signals can indicate a reputation, importance, or popularity that the users of such applications place upon the point of interest. Thus, the score of a virtual point of interest in the game can track the importance of the real-world point of interest to the game-playing community, as indicated by associated online activity.

The scoring metric can be tailored to meet any game design or to achieve any overarching game goals. For example, the scoring metric can incorporate signals in both a positive and negative fashion, such that the resulting score is tailored to the game designer's goals. As another example, selected signals can carry increased weight in order to incentivize player activity with the data source providing such selected signals. Thus, a player interested in increasing or otherwise altering a score in the game can be incentivized to interact with a selected web-based technology or social media platform.

Exemplary signals that can be incorporated into the scoring metric by the scoring engine include a plurality of online interactions or activity. For example, signals can be collected from geographic information systems, search engines, social media, or other suitable applications or services, including, but not limited to, directories, reviews, location databases, commercial databases, or other suitable data. The scores assigned to the points of interest using the scoring metric can be updated dynamically as game-players or other web-users interact with, discuss, or search for the point of interest.

Further, the scores can be provided to any game or style of game in which it would be desirable to score virtual points of interest within a virtual world having a geography that parallels at least a portion of the real-world. In particular, the result of using the present scoring metric is that any game that considers real world points of interest as core data becomes able to express the value of those points of interest in a way that makes sense from the perspective of a game player. The parallel virtual points of interest reflect the importance and popularity of points of interest in the real world, as influenced by the game-playing community.

In situations in which the incorporated signals discussed herein collect personal information about users or make use of personal information, the user can be provided with an opportunity to control whether programs or features collect user information (e.g., information about a user's social network, social actions or activities, a user's preferences, or a user's current location). In addition, certain data can be treated in one or more ways before it is stored, incorporated into a signal, or otherwise used, so that personally identifiable information is removed. For example, a user's identify can be treated so that no personally identifiable information can be determined for the user, or a user's geographic location can be generalized where location information is obtained (such as to a city, ZIP code, or state level), so that a particular location of a user cannot be determined. Thus, the user can have control over how information is collected about the user and used by the systems and methods discussed herein.

### Exemplary Scoring Engine and Associated Signals

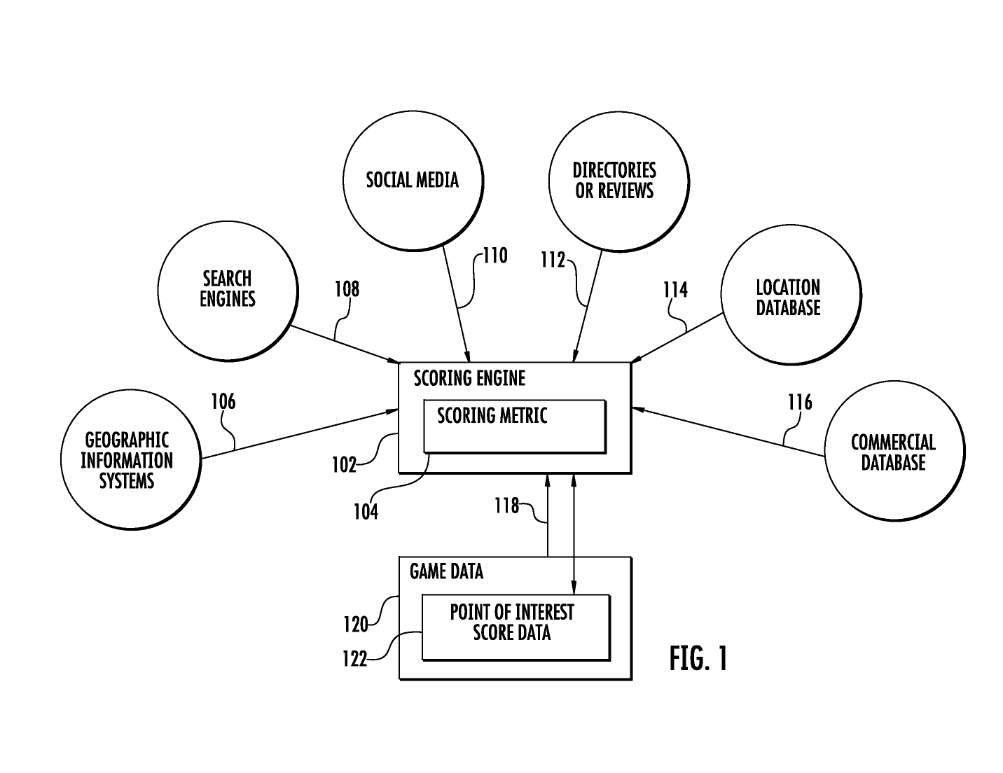

FIG. 1 depicts an exemplary scoring engine 102 and associated signals 106-118 according to an exemplary embodiment of the present disclosure. Scoring engine 102 can determine a score for a virtual point of interest included in a virtual world of a parallel reality game according to a scoring metric 104. More particularly, scoring engine 102 can determine a score for virtual points of interest based upon the application of signals 106-118 to scoring metric 104. The score can be assigned to the virtual point of interest by generating or otherwise modifying game data 120. In particular, point of interest score data 122 can be generated or otherwise modified such that the score determined by scoring engine 102 is assigned to the virtual point of interest and stored for use by the parallel reality game.

A virtual point of interest can be the parallel virtual counterpart to any real world point of interest. As used herein, a “real world point of interest” refers to any feature, landmark, point of interest, or other object or event associated with a geographic location. Exemplary points of interest include, without limitation, a business, restaurant, retail outlet, coffee shop, bar, music venue, attraction, museum, theme park, arena, stadium, festival, building, monument, road crossing, clearing in a forest, topographical feature, organization, entity, or other suitable point of interest. In addition, real world points of interest can be defined or identified by a player and incorporated into game data based upon a player request or player-provided information. Generally, any real world feature can be represented by a parallel virtual point of interest in the virtual world. A score can be determined and assigned to each virtual point of interest by scoring engine 102.

Scoring engine 102 can be implemented using any suitable form of computing device. Generally, such suitable computing device can include one or more processors, microprocessors, microcomputers, memory, network interface or other suitable components for implementing scoring engine 102. For example, a memory can store computer-readable instructions that when executed by the computing device cause the computing device to perform operations which implement scoring engine 102.

As an example, scoring engine 102 can be implemented on a server and one or more remote gaming devices can access scoring engine 102 over a network. As another example, scoring engine 102 can be implemented directly on the same machine providing game play to the player, including, without limitation, a mobile phone, a tablet, a desktop computer, a dedicated gaming platform, or other suitable computing devices. In such instance, the scoring engine can be accessed as a program library.

Scoring engine can determine a score for a virtual point of interest according to scoring metric 104. Scoring metric 104 can be included in hardware, firmware, and/or software controlling a general purpose processor. In one embodiment, scoring metric 104 can be program code files stored on a storage device, loaded into memory and executed by a processor or can be provided from computer program products, for example, computer executable instructions that are stored in a tangible computer-readable storage medium such as a RAM hard disk or optical or magnetic media.

The score determined by scoring engine 102 according to scoring metric 104 can take many various forms, each of which can be used to satisfy the present disclosure. Exemplary scores can include, without limitation, a numerical score on a scale of one hundred (78/100); a numerical score without an associated ceiling or scale (10,534); a monetary score ($34.67); a tiered score (Level 5); a categorical or descriptive score (Top Performer); or any other suitable form of score. In addition, such scores can be modified or tailored according to a particular game in which such scores are implemented. For example, scores can include bonuses, combos, or other modifiers. As another example, different scores can be provided to each player based on player customization and game play.

Returning to FIG. 1, signals 106-118 can be collected from one or more web-based technology or social media applications or services or from other information providers, such as location databases or commercial databases. For example signals 106-118 can be collected over a network, such as the Internet, according to known techniques. Signals 106-118 can indicate a reputation, importance, or popularity that the users of such applications place upon the real world point of interest. As another example, signals 106-118 can indicate a geographic region or location or other geographic information concerning the real world point of interest or its surroundings. Thus, the score of a virtual point of interest in the game can track the importance of the real-world point of interest to the game-playing community, as indicated by the associated online activity and other suitable information represented by signals 106-118.

One of skill in the art, in light of the disclosures contained herein, will appreciate that signals 106-118, as shown in FIG. 1, are exemplary in nature and that the present disclosure is not limited to such signals. In particular, any suitable signals can be incorporated into scoring metric 104 and used by scoring engine 102, including any signals that provide an indication of an online reputation or popularity of a real world point of interest.

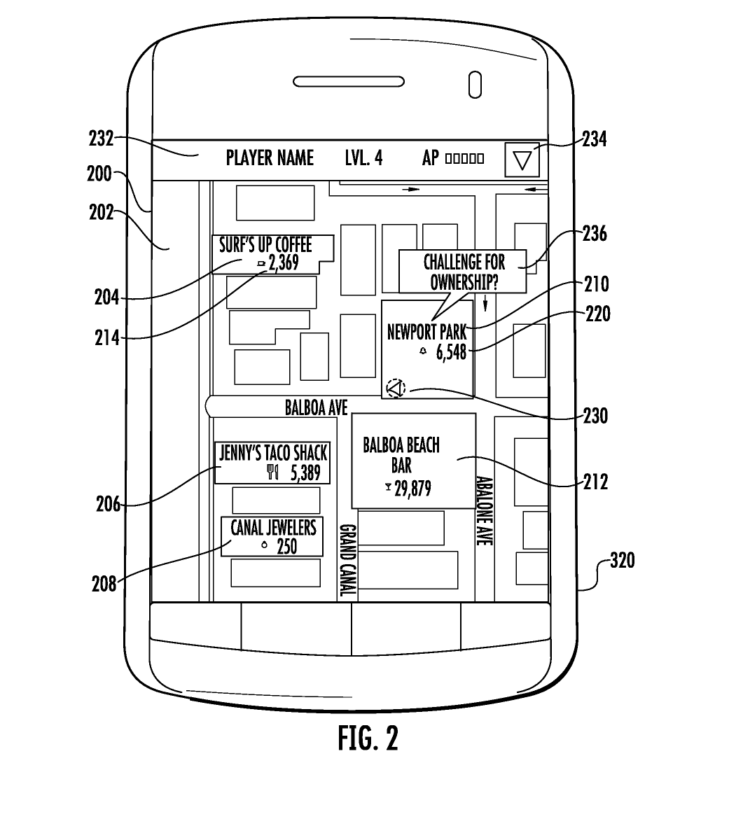

In addition, while signals 106-118 will be discussed with reference to virtual points of interest 204-212 depicted in game interface 200 of FIG. 2, such discussion is provided only for exemplary purposes and the present disclosure is not limited to the embodiment depicted in FIG. 2.

In one aspect of the present disclosure, scoring engine 102 can incorporate one or more signals 106 from a geographic information system. A geographic information system can provide for the archiving, retrieving, and manipulation of geospatial data that has been indexed and stored according to geographic coordinates, such as latitude, longitude, and altitude coordinates. A geographic information system can combine geospatial data such as satellite imagery, photographs, maps, models, tables, and other geospatial data with Internet search capability so as to enable a user to view imagery of the planet (e.g. as a portion of a virtual globe) and related information (e.g., locales such as islands and cities; and points of interest such as local restaurants, hospitals, parks, hotels, and schools). As such, data concerning the real-world point of interest can be included in the geographic information system and provided to a user of the geographic information system.

Signal 106 can describe a popularity or frequency of interaction associated with a real world point of interest represented in a geographic information system. As an example, signal 106 can describe the number of instances in which a placemark associated with the real world point of interest has been returned as a search result in response to a user search query.

A user of a geographic information system can input a search query into the geographic information system in an attempt to identify the location of one or more real world points of interest or to become aware of real world points of interest in a given area. Such search query can be of varying scope or specificity. Exemplary search queries can range from directly naming the real world point of interest, such as “Balboa Beach Bar, 123 Grand Canal St” to generally describing a location and/or category of point of interest, such as “bookstore,” “martinis,” or “coffee, Balboa Island, Calif.”

A geographic information system can return a plurality of placemarks in response to the search query. Such placemarks can indicate the location of one or more real world points of interest that are relevant to the search query. For example, in the event that a user of a geographic information system entered the search query “Balboa Beach Bar, 123 Grand Canal St,” the geographic information system can return a placemark indicating the location of the real world point of interest, Balboa Beach Bar.

In the event that the user entered a search query that generally describes a category of point of interest, such as “coffee, Balboa Island, Calif.,” then the geographic information system can return a plurality of placemarks indicating the location of various coffee shops which may be relevant to the specific search query. For example, the plurality of placemarks can include a placemark indicating the location of a real world point of interest, Surf's Up Coffee.

In such fashion, a geographic information system can return a placemark associated with a real world point of interest as a search result in response to a user search query. Signal 106 can describe the number of instances in which such a placemark is returned as a search result and can be incorporated into scoring metric 104.

Generally, the score assigned to a virtual point of interest by scoring engine 102 is positively correlated to the number of instances in which a placemark associated with the parallel real world point of interest is returned as a search result by the geographic information system. Thus, a higher score will be awarded if the real world point of interest is frequently returned as a search result by the geographic information system. Likewise, a lower score will be awarded if the real world point of interest is infrequently or never returned as a search result.

While the term “placemark” has been used herein, one of skill in the art, in light of the disclosures contained herein, will appreciate that such term is exemplary in nature. In particular, an exemplary geographic information system can return results in other forms than placemarks, including in a textual format. Signal 106 can generally describe the number of instances in which a point of interest is implicated in a search result, independent of the particular format in which the point of interest is presented to the user.

As another example, signal 106 can describe the number of instances in which the real world point of interest is depicted in a geographic information system, regardless of whether the real world point of interest is depicted as a search result or simply during the routine display of geographic information. For example, a user that zooms in, pans to, or otherwise requests or loads a certain geographic area can be presented with indicators of some or all points of interest that are located in such geographic area, without having entered a specific search query.

Signal 106 can reflect the number of instances in which an indicator associated with a real world point of interest is displayed in any fashion, including instances in which the indicator is presented during the routine display of geographic information. Generally, a greater number of instances in which the real world point of interest is depicted or otherwise indicated in the geographic information system can result in a higher score assigned to the parallel virtual point of interest in the game by scoring engine 102. Likewise, a lesser number of instances in which the real world point of interest is depicted or otherwise indicated in the geographic information system can result in a lower score.

As yet another example, signal 106 can describe the number of instances in which a user selects the point of interest when returned as a search result or otherwise requests more information concerning the point of interest, known in some instances as a “click through rate.” One of skill in the art, in light of the disclosures contained herein, will appreciate that a point of interest can be selected by a user of a geographic information system in a number of fashions, including, for example, clicking on the placemark or requesting directions to the location of the point of interest.

In some implementations, scoring metric 104 can accord more weight to click throughs or click through rates than it does to the raw number of instances in which the point of interest is depicted. However, in general, an increase in click throughs, click through rates, or number of depictions all have a positive impact on the score determined by scoring engine 102 according to scoring metric 104.

As another example, signal 106 can describe the number of instances in which data associated with the real world point of interest and stored in the geographic information system is generated or otherwise modified by one or more users of the geographic information system.

According to another aspect of the present disclosure, scoring engine 102 can incorporate one or more signals 108 from a search engine. As an example, signal 108 can describe the number of instances in which a real world point of interest or an item of content associated with the real world point of interest is returned as a result by the search engine.

A user of a search engine can enter a search query in an attempt to obtain a listing of web pages or other online content relevant to the subject of the search query. Such search query can be of varying scope or specificity. Exemplary search queries can range from directly naming the real world point of interest, such as “Balboa Beach Bar, 123 Grand Canal St” to generally describing a location, category of point of interest, or other identifier, such as “best bookstore in Newport,” “where can I kayak?,” or “coffee, Balboa Island, Calif.”

A search engine can return a plurality of web pages or other online content in response to the search query. Such web pages can provide additional content that is relevant to the search query and can include information associated with the real world point of interest. For example, in the event that a user of a search engine entered the search query “Balboa Beach Bar, 123 Grand Canal St,” the search engine can return a web page associated with the real world point of interest, Balboa Beach Bar.

In the event that the user entered a search query that generally describes a category of point of interest, such as “coffee, Balboa Island, Calif.,” then the search engine can return a plurality of web pages or other content which may be relevant to the specific search query. For example, the plurality of web pages can include a web page associated with the real world point of interest, Surfs Up Coffee. Alternatively, the search engine can return a web page that includes other relevant content, such as a web page listing and rating all coffee shops in the Balboa Island area, including Surf's Up Coffee.

In such fashion, a search engine can return a web page or other content associated with a real world point of interest as a search result in response to a user search query. Signal 108 can describe the number of instances in which such a web page or other content is returned as a search result and can be incorporated into scoring metric 104.

Generally, the score assigned to a virtual point of interest by scoring engine 102 can be positively correlated to the number of instances in which a web page associated with the real world point of interest is returned as a search result by the search engine. Thus, a virtual point of interest can receive a higher score if a web page associated with the real world point of interest is frequently returned as a search result. Likewise, the virtual point of interest can receive a lower score if a web page associated with the real world point of interest is infrequently or never returned as a search result.

While the general operation of a generic search engine has been described above, search engines can be altered or customized to return only results that meet certain criteria. For example, a search engine can be customized so that it returns only recently generated content, such as news stories. Alternatively, a search engine can be personalized according to a user's preferences and return only web pages that discuss certain selected topics or return only content provided by selected, preferred content providers.

As another example, a search engine can be used to power a digest, compilation, or other type of aggregator such that articles, web pages, or other content are selected and provided to a user without requiring the user to enter a specific search query. In some instances, such an aggregator may be included in one or more social media platforms.

One of skill in the art, in light of the disclosures contained herein, will understand that the term “search engine,” as used herein, includes such variations of search engines and applications that incorporate or are powered by a search engine. In particular, signal 108 can describe the number of instances in which an item of content or web page associated with a real world point of interest is returned or presented by any search engine, feed reader, aggregator, or other suitable content providing web resource, whether stand alone or as an element of a larger web service.

As another example, signal 108 can describe the number of instances in which a user selects a web page or other item of content associated with the real world point of interest when it is returned as a search result or presented by a search engine or aggregator. For example, in the event that the user entered a search query that generally describes a category of point of interest, such as “coffee, Balboa Island, Calif.,” then the search engine can return a plurality of web pages that may be relevant to the specific search query, including a web page associated with the real world point of interest, Surf's Up Coffee. Signal 108 can describe the number of instances in which the web page associated with Surf's Up Coffee is selected by the user, also known as a “click through.”

Alternatively, signal 108 can be expressed as a percentage and termed a “click through rate.” The click through rate can describe the number of times a user selects a web page associated with a point of interest divided by the number of times a web page associated with the point of interest is returned as a search result or otherwise presented to a user. As such, a higher click through rate indicates that the real world point of interest is generally more popular, more sought after by the web community, or more directly satisfies a search query. Likewise, a lower click through rate can indicate that the real world point of interest is less popular, less sought after, or fails to satisfy the search query.

In some implementations, scoring metric 104 can accord more weight to click throughs or click through rates than it does to the raw number of instances in which a web page associated with a real world point of interest is returned or presented by a search engine. However, in general, an increase in click throughs, click through rates, or number of instances in which a related web page is returned can all have a positive impact on the score determined by scoring engine 102 according to scoring metric 104.

According to another aspect of the present disclosure, scoring engine 102 can incorporate one or more signals 110 from one or more social media platforms. Social media platforms provide for interaction among people. For example, users can create, share, exchange, or comment on content. Such content can be textual, videographic, photographic, or other suitable formats. Social media platforms can include forums, weblogs, microblogging, wikis, or other social media networks for sharing photographs, videos, and/or textual commentary.

As an example, signal 110 can describe the number of instances in which a real world point of interest is referenced in a social media network. In particular, to the extent that users of a social media platform provide affirmative consent after being informed of what data is collected, how it is collected, and how such data is used, social media content such as postings and other user-generated content can be analyzed to determine whether one or more real world points of interest are referenced by the content.

As another example, signal 110 can describe a virality factor of a social media posting or other content associated with the real world point of interest. For example, a social media platform can allow a second user to share, rebroadcast, or otherwise signal approval of a posting or other content provided by a first user. The number of times a posting or other content is shared or rebroadcasted can be indicative of whether the point of interest referenced in such posting is a popular topic of discussion or otherwise generates interest among users of the social media platform. Thus, a larger number of shares or rebroadcasts corresponds to a higher virality factor, while a lower number of shares or rebroadcasts corresponds to a lower virality factor.

Thus, signal 110 can describe the virality factor associated with a social media posting or content that references a real world point of interest by indicating the number of times the posting or content is shared, rebroadcasted, or otherwise receives approval, verification, or recommendation from other users. Signal 110 can also describe the virality factor of a social media posting or other content associated with a real world point of interest by indicating the number of replies that the posting or other content engenders. Generally, a virtual point of interest will receive a higher score from scoring engine 102 if postings that reference the parallel real world point of interest receive a larger number of shares, rebroadcasts, or replies (i.e. exhibit a high virality factor). Likewise, a virtual point of interest can receive a lower score if postings that reference the parallel real world point of interest exhibit a low virality factor.

As yet another example, signal 110 can describe the number of instances in which one or more users of a social media platform has selected an indicator provided by the social media platform that indicates that the one or more users enjoys, approves, or recommends the real world point of interest. For example, a social media platform can provide an indicator that users can select with respect to a person, posting, or other item, such as the real world point of interest. By selecting the indicator, users of the social media platform can signal that they approve or otherwise enjoy the real world point of interest. Generally, a virtual point of interest will receive a higher score from scoring engine 102 if a larger number of users have indicated that they approve of the parallel real world point of interest. Likewise, a virtual point of interest can receive a lower score if a smaller number of users have indicated that they approve of the real world point of interest. Further, if users have indicated that they disapprove of the parallel real world point of interest, the score assigned to the virtual point of interest can be negatively affected.

As another example, signal 110 can describe the number of friends, followers, or other connections that a social media account associated with the real world point of interest has accumulated in a social media platform. For example, a social media platform can allow a user to follow or befriend another user or account. By choosing to befriend or follow the account associated with the real world point of interest, users of the social media platform are signaling that they approve of or are interested in the real world point of interest. Generally, a virtual point of interest will receive a higher score from scoring engine 102 if an account associated with the parallel real world point of interest has a larger number of followers, friends, or other connections. Likewise, the virtual point of interest can receive a lower score if an account associated with the parallel real world point of interest has a smaller number of followers, friends, or other connections.

As yet another example, signal 110 can describe the number of instances in which one or more users of a social media platform have indicated that they are located at the real world point of interest. For example, a social media platform can allow a user to notify or share with her network that she is located in a certain region, area, or real world point of interest. In some instances this action can be termed a “check-in.”

To the extent that such social media users provide affirmative consent after being informed of what data is collected, how it is collected, and how such data is used, the number of instances in which one or more users of a social media platform have indicated that they are located at a real world point of interest can be analyzed and described by a signal 110.

If a larger number of users of a social media platform have indicated that they are located at the real world point of interest, it can be assumed that the real world point of interest is generally more popular, maintains higher traffic, or is interesting to more members of the web community. As such, a virtual point of interest will receive a higher score according to scoring metric 104 if a larger number of users have indicated that they are located at the parallel real world point of interest. Likewise, the virtual point of interest can receive a lower score if a smaller number of users have indicated that they are located at the parallel real world point of interest.

According to another aspect of the present disclosure, scoring engine 102 can incorporate one or more signals 112 from one or more directories or reviews. In particular, a directory service can provide a listing of real world points of interest for specified locales. Some directory services can include elements of social networking, allowing users to provide reviews or other feedback or commentary regarding each real world point of interest.

As an example, signal 112 can describe the number of reviews a real world point of interest has received in a web-based directory service. If a large number of reviews are generated or submitted for a real world point of interest, then the real world point of interest is likely high profile, a topic of conversation, or interesting to more members of the web community. Thus, a virtual point of interest will receive a higher score according to scoring metric 104 if the parallel real world point of interest receives a larger number of reviews in a directory service. Likewise, the virtual point of interest can receive a lower score if the parallel real world point of interest receives a smaller number of reviews.

As another example, signal 112 can describe the relative positivity or negativity associated with each review provided to the directory service by a user, also known as a “positivity factor.” In particular, to the extent that users of a directory service provide affirmative consent after being informed of what data is collected, how it is collected, and how such data is used, user-generated reviews can be analyzed to determine a positivity factor associated with such review. One of skill in the art, in light of the disclosures contained herein, will appreciate that there are many methods for determining a positivity factor for a review. Any of such methods can be used to satisfy the present disclosure, including any combination of those discussed above.

The positivity factors respectively associated with the plurality of reviews can be aggregated to determine a total positivity of all reviews available for analysis. If total positivity is high, either as a raw number or on a relative basis, then scoring metric 104 can reward the virtual point of interest with a higher score. To the contrary, if total positivity is low (i.e. high negativity) then scoring metric 104 can reward fewer points to the virtual point of interest. In some implementations, a real world point of interest that receives reviews of a high negativity (i.e. low positivity factor) can result in subtracted points or otherwise penalize the score of the parallel virtual point of interest, per scoring metric 104.

According to yet another aspect of the present disclosure, scoring engine 102 can incorporate one or more signals 114 from a location database. In particular, a location database can provide the location of each relevant real world point of interest. In some instances, the location database can provide additional statistics, data, or other descriptive information with respect to each relevant real world point of interest or with respect to the regions or locations in which such real world points of interest are located.

One of skill in the art, in light of the disclosures provided herein, will appreciate that a location database can be included within a geographic information system. In such instance, signal 114 can be considered analogous to signal 106. However, a location database can also be independent of a geographic information system. As such, signal 114 is provided here for the purposes of clarity.

As an example, signal 114 can provide the latitude and longitude of the point of interest. In some instances such latitude and longitude can be known as the point of interest's “geocode.” As another example, signal 114 can provide the country, state/region, zip code, neighborhood, street address, or other location information associated with the point of interest. Alternatively, such location information (i.e. state, zip code, etc.) can be determined by scoring engine 102 based upon a geocode provided by signal 114.

Scoring metric 104 can provide for a higher or lower score depending on the location of the real world point of interest. In one implementation, scoring metric 104 provides differing scores for virtual points of interest based on the country in which their respective real world points of interest are located. For example, points of interest located in countries with higher Internet usage can receive a higher score according to scoring metric 104. As another example, points of interest located in countries with a higher GDP can receive a higher score according to scoring metric 104. In alternative implementations, scoring metric 104 applies the same or similar analysis at the region, state, zip code, neighborhood, or street level instead of at the country level. Generally, scoring metric 104 can be tailored to incorporate any suitable geographic information. Likewise, scoring metric 104 can incorporate each of these factors in a negative fashion as well, if desirable.

As another example, signal 114 can provide a categorical description of the real world point of interest. Such categorical description can vary in scope from a broad description, such as “commercial,” or “residential,” to more narrow descriptions, such as “gas station,” “coffee shop,” or “jewelry store.”

Scoring metric 104 can provide for a higher or lower score depending on the category of the real world point of interest. In particular, more desirable categories, from the perspective of the online game-playing community, can receive higher scores. For example, a video game store or an electronics store can receive an increased score. As another example, categories that provide significant real world practical value but would otherwise not receive high scores according to the principles discussed above can receive a higher score. For example, gas stations and parking garages provide a significant practical real world value. However, such categories are often not the subject of conversation in social media or otherwise highly trafficked on the Internet, and would therefore receive a lower score. As such, gas stations, parking garages, or other similar selected categories can receive a higher score to compensate for their practical value.

As yet another example, signal 114 can provide categorical descriptions or other information concerning a plurality of real world points of interest which neighbor, are adjacent to, or are otherwise related to the real world point of interest under consideration. For example, a parking garage near a highly regarded shopping center in a dense city center can be assigned a higher score than an identical parking garage that is located in a remote area without neighboring points of interest, such as a “Park and Ride.” As another example, real world points of interest that are located near public resources, such as public transit stations, can receive a higher score according to scoring metric 104. In such fashion, the score determined for a virtual point of interest can be based in part on information concerning the real world points of interest or geographic features surrounding the parallel real world point of interest.

According to another aspect of the present disclosure, scoring engine 102 can incorporate one or more signals 116 from a commercial database. A commercial database can provide information regarding the popularity or successfulness of a real world point of interest on a deal site, deal-of-the-day website, group coupon website, or other type of social commerce website. For example, a real world point of interest can offer a specific deal or offer to users of a social commerce website. If a larger number of users choose to participate or purchase the deal, then the real world point of interest is generally more sought after or popular among the web community.

Thus, signal 116 can describe the popularity or successfulness of one or more deals offered by a real world point of interest on a social commerce website. Generally, a virtual point of interest can receive a higher score from scoring engine 102 if deals offered by the parallel real world point of interest are popular or purchased by a larger number of users. Likewise, the virtual point of interest can receive a lower score if deals offered by the parallel real world point of interest are unpopular or fail to be purchased by a larger number of users.

A commercial database can also provide information regarding advertising partnerships between the real world point of interest and the game provider. For example, a real world point of interest can contract with the game provider to display advertisements on the real world point of interest's behalf Such advertisements can be internal or external to the parallel reality game. Generally, a virtual point of interest can receive a higher score from scoring engine 102 if an advertising partnership exists between the parallel real world point of interest and the game provider. Likewise, the virtual point of interest can receive a lower score if an advertising partnership does not exist between the parallel real world point of interest and the game provider.

According to another aspect of the present disclosure, scoring engine 102 can incorporate one or more signals 118 from the game data 120. The scores assigned to the virtual points of interest can be adjusted or modified due to game events, game features, or other game occurrences. For example, real world points of interest can participate or otherwise play a role in the game itself and the score assigned to their parallel virtual point of interest can be adjusted due to such participation. In addition, some or all of the features, applications, or services discussed above with respect to signals 106-116 can be incorporated into the parallel reality game. In such instance, any of the actions or features of scoring engine 102 and scoring metric 104 discussed above can be applied to a game data signal 118.

Further, one of skill in the art will appreciate that signals 106-116 can be limited or purged to reflect online activity associated with only a particular collection of individuals. For example, signals 106-116 can be controlled to reflect online activity associated with only players of the parallel reality game. In such fashion, the resulting scores assigned to the virtual point of interest can more accurately reflect a popularity of the parallel real world points of interest among the game playing community.

### Exemplary Game Interface

FIG. 2 depicts an exemplary game interface 200 according to an exemplary embodiment of the present disclosure. Game interface 200 can be presented to a player of the game. For example, game interface is shown in FIG. 2 as being presented on the display of a client device 320 as part of the interface between a player and the gaming system. Game interface 200 can be used to display the virtual world 202 and various other aspects of the parallel reality game, such as a player position 230 and the location of virtual points of interest 204, 206, 208, 210, and 212.

The virtual world 202 depicted in FIG. 2 is exemplary in nature, and is provided for the purposes of explanation, not limitation. Thus, while the game embodiment depicted in FIG. 2 shows a player position 230, the present disclosure is not limited to location-based games in which a player participates in the game by moving about in the real world. Instead, the present disclosure can be applied to or used in all games that include a virtual world that parallels at least a portion of the real world, whether such game includes location-based aspects or not.

Game interface 200 can also display game information 232 such as a player name, player level, or other suitable game information. A menu 234 can be included for accessing various game settings and other information associated with the game. One or more game communications 236 can be presented to the player to prompt player action, change preferences, or otherwise allow the player to participate in the game. Game communications can be audio, visual, or other suitable formats.

According to aspects of the present disclosure, a scoring engine or other suitable system can be used to determine and assign a score to virtual points of interest 204, 206, 208, 210, and 212. For example, as shown in game interface 200, virtual point of interest 204 can be assigned a score 214. Likewise, virtual point of interest 210 can be assigned a score 220.

While FIG. 2 shows virtual point of interest 204 with a single score 214, such depiction is exemplary in nature and not intended to limit the disclosure to such depiction. In particular, in alternative implementations of the present disclosure, the score 214 provided for point of interest 204 can be different for each player of the game. More particularly, scoring engine 102 can incorporate user customization or user preferences in order to tailor score 214 for such player. As an example, if a player provides an indication that public transportation is her primary mode of transport and consents to the use of such data, scores can be higher for points of interest that are located within a closer proximity to public transportation centers or routes.

Generally, the present disclosure can be tailored to benefit any style of game and satisfy many different game objectives. For example, multiple scores can be determined and assigned to each point of interest based upon different game play factors, levels, teams, or player attributes. As another example, virtual point of interest game scores can be the basis for a virtual currency included in the game. As yet another example, the scores assigned to the virtual points of interest can be used as conversion factors when converting real world currency into and out of game play.

In addition, the term “game” as used herein should be broadly construed to include both traditional and non-traditional gaming formats. For example, programs or applications that provide a parallel reality should be considered games even if they do not define clear game objectives or provide an overarching game narrative. One of skill in the art, in light of the disclosures provided herein, will appreciate that modern games define a spectrum of formats, including games that provide a second, fictional life or other styles of gameplay that include business aspects or are not strictly dedicated to providing lighthearted pleasure.

### Exemplary Parallel Reality Gaming System

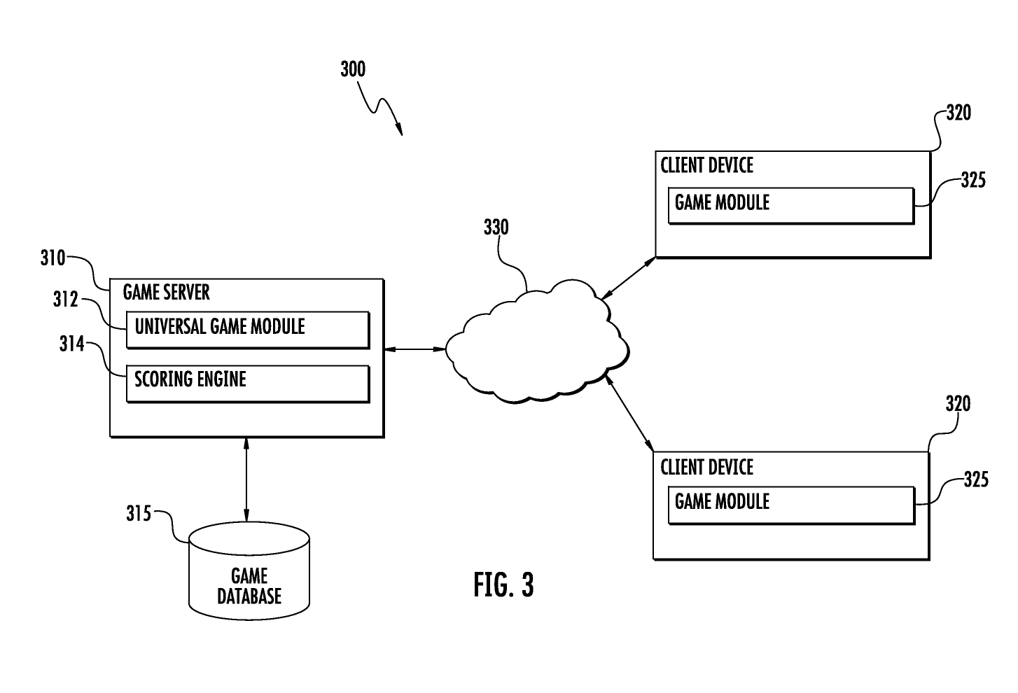

Exemplary computer-implemented gaming systems according to exemplary embodiments of the present disclosure will now be set forth. The present subject matter will be discussed with reference to an embodiment of a parallel reality game, depicted in FIG. 3, that includes a client-server architecture and elements of location-based gaming. The present disclosure is not limited to such embodiment, but instead applies broadly to any game that includes a virtual world that parallels at least a portion of the real world. In addition, the inherent flexibility of computer-based systems allows for a great variety of possible configurations, combinations, and divisions of tasks and functionality between and among the components of the system. For instance, the systems and methods according to aspects of the present disclosure can be implemented using a single computing device or across multiple computing devices.

FIG. 3 illustrates an exemplary computer-implemented gaming system 300 configured in accordance with an embodiment of the present disclosure. The gaming system 300 provides for the interaction of a plurality of players in a virtual world having a geography that parallels at least a portion of the real world. In particular, a geographic area in the real world can be linked or mapped directly to a corresponding area in the virtual world.

The system 300 can include a client-server architecture, where a game server 310 communicates with one or more clients 320 over a network 330. Although two clients 320 are illustrated in FIG. 1, any number of clients 320 can be connected to the game server 310 over the network 330. The server 310 can host a universal gaming module 312 that controls aspects of the parallel reality game for all players and receives and processes each player's input in the game. On the client-side, each client 320 can include a gaming module 325 that operates as a gaming application so as to provide a user with an interface to the system 300. The game server 310 transmits game data over the network 330 to the client 320 for use by the gaming module 325 at the client 320 to provide local versions (e.g. portions of the virtual world specific to player locations) of the game to players at locations remote from the game server 310.

It will be appreciated that the term “module” refers to computer logic utilized to provide desired functionality. Thus, a module can be implemented in hardware, firmware and/or software controlling a general purpose processor. In one embodiment, the modules are program code files stored on the storage device, loaded into memory and executed by a processor or can be provided from computer program products, for example, computer executable instructions that are stored in a tangible computer-readable storage medium such as RAM hard disk or optical or magnetic media.

The game server 310 can be implemented using a computing device and can include a processor and a memory. The memory can store instructions which cause the processor to perform operations. The game server 310 can include or can be in communication with a game database 315. The game database 315 stores game data used in the parallel reality game to be served or provided to the client(s) 320 over the network 330.

The game data stored in the game database 315 can include: (1) data associated with the virtual world in the parallel reality game (e.g. imagery data used to render the virtual world on a display device, geographic coordinates of locations in the virtual world, etc.); (2) data associated with players of the parallel reality game (e.g. player information, player experience level, player currency, player energy level, player preferences, team information, faction information, etc.); (3) data associated with game objectives (e.g. data associated with current game objectives, status of game objectives, past game objectives, future game objectives, desired game objectives, etc.); (4) data associated with virtual elements in the virtual world (e.g. positions of virtual elements such as virtual points of interest, types of virtual elements, game objectives associated with virtual elements; scores for virtual points of interest etc.); (5) data associated with real world objects, landmarks, or other real world points of interest that are linked to virtual points of interest (e.g. location of real world points of interest, description of real world points of interest, etc.); (6) Game status (e.g. current number of players, current status of game objectives, player leaderboard, etc.); (7) data associated with player actions/input (e.g. current player positions, past player positions, player moves, player input, player queries, player communications, etc.); and (8) any other data used, related to, or obtained during implementation of the parallel reality game. The game data stored in the game database 315 can be populated either offline or in real time by system administrators and/or by data received from users/players of the system 300, such as from one or more clients 320 over the network 330.

The game server 310 can be configured to receive requests for game data from one or more clients 320 (for instance, via remote procedure calls (RPCs)) and to respond to those requests via the network 330. For instance, the game server 310 can encode game data in one or more data files and provide the data files to the client 320. In addition, the game server 310 can be configured to receive game data (e.g. player positions, player actions, player input, etc.) from one or more clients 320 via the network 330. For instance, the client device 320 can be configured to periodically send player input, player location, and other updates to the game server 310, which the game server 310 uses to update game data in the game database 315 to reflect any and all changed conditions for the game.

As illustrated, the game server 310 can include a universal game module 312. The universal game module 312 hosts the parallel reality game for all players and acts as the authoritative source for the current status of the parallel reality game for all players. The universal game module 312 receives game data from clients 320 (e.g. player input, player position, player actions, player status, landmark information, etc.) and incorporates the game data received into the overall parallel reality game for all players. The universal game module 312 can also manage the delivery of game data to the clients 320 over the network 330.

Other modules can be used with the game server 310. Any number of modules can be programmed or otherwise configured to carry out the server-side functionality described herein. In addition, the various components on the server-side can be rearranged. For instance, the game database 315 can be integrated into the game server 310. Other configurations will be apparent in light of this disclosure and the present disclosure is not intended to be limited to any particular configuration.

According to exemplary aspects of the present disclosure, the game server 310 can also include a scoring engine 314. Scoring engine 314 can determine a score for one or more virtual points of interest included in the parallel reality game. Scoring engine 314 can assign such score to the virtual point of interest by generating or otherwise modifying game data included in game database 315. In addition, although scoring engine 314 is depicted in FIG. 3 as being included within game server 310, scoring engine 314 can be implemented as a stand-alone computing device.

A client 320 can be any computing device that can be used by a player to interact with the gaming system 300. For instance, a client 320 can be a wireless device, a personal digital assistant (PDA), gaming device, cellular phone, smart phone, tablet, navigation system, handheld GPS system, dedicated gaming platform, personal computer, or other such device. In short, a client 320 can be any computer-device or system that can execute a gaming module 325 to allow a player to interact with the game system 300.

The client 320 can include a processor and a memory. The memory can store instructions which cause the processor to perform operations. The client 320 can include various input/output devices for providing and receiving information from a player, such as a display screen, touch screen, touch pad, controller, motion sensor, data entry keys, speakers, and/or a microphone suitable for voice recognition. The client 320 can further include a network interface for providing communications over the network 330.

The gaming module 325 executed by the client 320 provides an interface between a player and the parallel reality game. The gaming module 325 can present a game interface on a display device associated with the client 320 that displays a virtual world associated with the game and allows a user to interact in the virtual world to perform various game objectives. The gaming module 325 can also control various other outputs to allow a player to interact with the game without requiring the player to view a display screen. For instance, the gaming module 325 can control various audio, vibratory, or other notifications that allow the player to play the game without looking at the display screen. The gaming module 325 can access game data received from the game server 310 to provide an accurate representation of the game to the user. The gaming module 325 can receive and process player input and provide updates to the game server 310 over the network 330.

The network 330 can be any type of communications network, such as a local area network (e.g. intranet), wide area network (e.g. Internet), or some combination thereof. The network can also include a direct connection between a client 320 and the game server 310. In general, communication between the game server 310 and a client 320 can be carried via a network interface using any type of wired and/or wireless connection, using a variety of communication protocols (e.g. TCP/IP, HTTP, SMTP, FTP), encodings or formats (e.g. HTML, XML), and/or protection schemes (e.g. VPN, secure HTTP, SSL).

### Exemplary Methods for Scoring Points of Interest

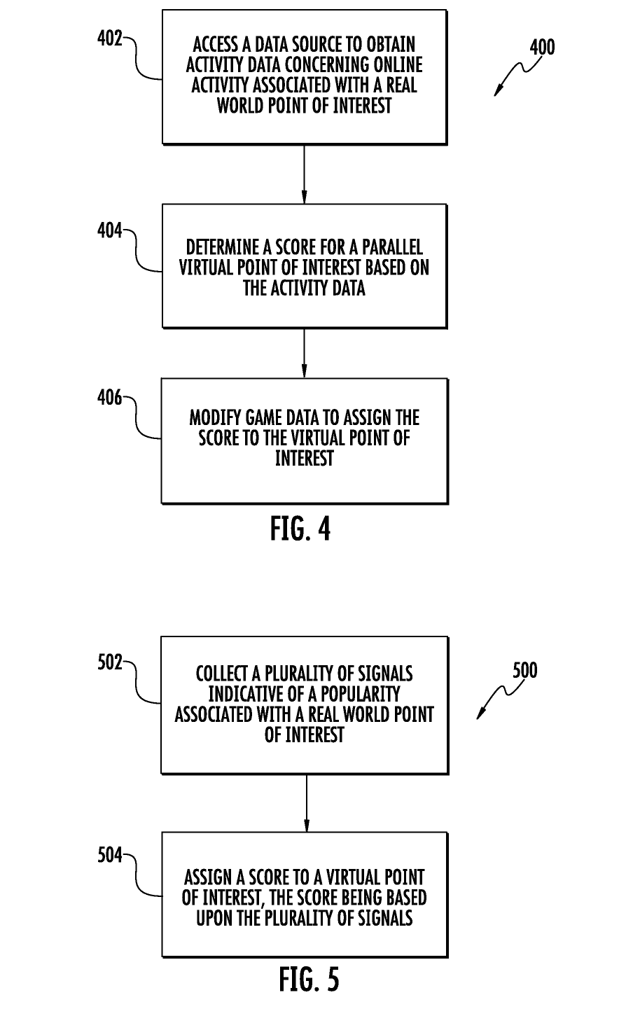

FIG. 4 depicts a flow chart of an exemplary computer-implemented method (400) for assigning a score to a virtual point of interest included in a virtual world associated with a parallel reality game according to an exemplary embodiment of the present disclosure. While exemplary computer-implemented method (400) will be discussed with reference to FIG. 1, computer-implemented method (400) can be implemented using any suitable computing system, including gaming system 300 of FIG. 3. In addition, although FIG. 4 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

At (402) a data source is accessed to obtain activity data. The activity data can concern online activity associated with a real world point of interest. For example, scoring engine 102 can access one or more geographic information systems, search engines, social media platforms, local directories, location databases, commercial database, game databases, or other suitable data sources. In particular, scoring engine 102 can obtain activity data in the form of signals 106-118.

At (404) a score can be determined for a virtual point of interest based on the activity data. The virtual point of interest can be included in a virtual world that parallels at least a portion of the real world such that the virtual point of interest parallels the real world point of interest of step (402). For example, scoring engine 102 can determine a score for the virtual point of interest based on signals 106-118. More particularly, scoring engine can apply signals 106-118 to scoring metric 104 to determine the score for the virtual point of interest. Scoring metric 104 can provide a defined algorithm or method of determining a score given certain incoming signals. In such fashion, a score can be determined for the virtual point of interest based on the activity.

At (406) game data can be modified to assign the score to the virtual point of interest. For example, game data 120 can include a plurality of data types that form the basis of the parallel reality game. In particular, game data can include point of interest score data 122. Point of interest score data 122 can store a plurality of scores respectively associated with a plurality of virtual points of interest included in the virtual world associated with the parallel reality game. As an example, scoring engine 102 can generate or otherwise modify point of interest score data 122 to assign the score determined at (404) to the virtual point of interest.

FIG. 5 depicts a flow chart of an exemplary computer-implemented method (500) for assigning a score to a virtual point of interest included in a virtual world associated with a parallel reality game according to an exemplary embodiment of the present disclosure. While exemplary computer-implemented method (500) will be discussed with reference to FIG. 1, computer-implemented method (500) can be implemented using any suitable computing system, including gaming system 300 of FIG. 3. In addition, although FIG. 5 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

At (502) a plurality of signals are collected. Such signals can be indicative of a popularity associated with a real world point of interest. For example, scoring engine 102 can collect signals 106-118. Signals 106-118 can indicate a popularity associated with a real world point of interest by describing various forms of activity or other attributes associated with the real world point of interest.

At (504) a score is assigned to a virtual point of interest. The score can be based upon the plurality of signals. The virtual point of interest can be included in a virtual world that parallels at least a portion of the real world such that the virtual point of interest parallels the real world point of interest of step (502). For example, a score can be assigned to the virtual point of interest by scoring engine 102. The score can be based on signals 106-118.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A computer-implemented method for assigning a score to a virtual point of interest included in a virtual world associated with a parallel reality game, the virtual world having a geography that parallels at least a portion of the geography of the real world such that the virtual point of interest parallels a real world point of interest, the method comprising:
accessing a data source to obtain activity data concerning online activity associated with the real world point of interest;
determining a score for the virtual point of interest based on the activity data; and
modifying game data associated with the parallel reality game to assign the score to the virtual point of interest.

2. The computer-implemented method of claim 1, wherein the activity data is indicative of a degree of importance attributed to the real world point of interest by one or more users of one or more web services.

3. The computer-implemented method of claim 1, wherein the activity data comprises the number of instances in which an item of content associated with the real world point of interest is returned as a search result in a web search.

4. The computer-implemented method of claim 3, wherein the activity data further comprises the number of instances in which the item of content associated with the real world point of interest is selected when the item of content is returned as a search result in a web search.

5. The computer-implemented method of claim 1, wherein the activity data comprises the number of instances in which an indicator associated with the real world point of interest is displayed in a geographic information system.

6. The computer-implemented method of claim 1, wherein the activity data comprises the number of instances in which one or more users of a web service has indicated that they are located at the real world point of interest.

7. The computer-implemented method of claim 1, wherein the activity data comprises the number of instances in which one or more users of a web service has selected an indicator provided by the web service and associated with the real world point of interest, the indicator indicating that the one or more users approves of the real world point of interest.

8. The computer-implemented method of claim 1, wherein the activity data comprises the number of instances in which the real world point of interest is referenced in a social media network.

9. The computer-implemented method of claim 1, wherein the activity data comprises a virality factor associated with one or more social media postings that reference the real world point of interest.

10. The computer-implemented method of claim 1, wherein the activity data comprises the number of instances in which a review of the real world point of interest has been submitted by one or more users to a web service.

11. The computer-implemented method of claim 1, wherein the activity data comprises a positivity factor associated with one or more reviews of the real world point of interest submitted by one or more users to a web service.

12. The computer-implemented method of claim 1, wherein the activity data comprises the number of users that accepted a deal offered by the real world point of interest on a social commerce website.

13. The computer-implemented method of claim 1, further comprising accessing a second data source to obtain location data concerning the location of the real world point of interest in the real world, wherein the score for the virtual point of interest is determined based on the activity data and the location data.

14. The computer-implemented method of claim 1, further comprising accessing a second data source to obtain neighbor data concerning a plurality of points of interest that neighbor the real world point of interest, wherein the score for the virtual point of interest is determined based on the activity data and the neighbor data.

15. The computer-implemented method of claim 1, wherein accessing a data source to obtain activity data comprises accessing a plurality of data sources to obtain a plurality of signals concerning online activity and determining the score for the virtual point of interest based on the activity data comprises determining the score for the virtual point of interest based on the plurality of signals, the method further comprising allocating an increased weight to one of the plurality of signals when determining the score such that a game player is incentivized to interact with the data source providing such signal.

16. The computer-implemented method of claim 1, wherein the activity data comprises advertising partnership data associated with the real world point of interest.

17. A computer-based system for implementing a parallel reality game having a virtual world having a geography that parallels at least a portion of the real world, the computer-based system comprising:
a game server having a memory, a processor, and a network interface, the game server operable to provide, via the network interface, game data associated with the parallel reality game to a plurality of remote computing devices; and
a scoring engine configured to assign a score to a virtual point of interest included within the virtual world, the virtual point of interest paralleling a real world point of interest;
wherein the scoring engine is configured to assign the score to the virtual point of interest by performing operations comprising:
accessing a data source to obtain activity data concerning online activity associated with the real world point of interest;
determining the score for the virtual point of interest based on the activity data; and
modifying the game data to assign the score to the virtual point of interest.

18. The computer-based system of claim 17, wherein the activity data comprises the number of instances in which one or more users of a web service has indicated that they are located at the real world point of interest.

19. The computer-based system of claim 17, wherein the activity data comprises the number of instances in the real world point of interest is referenced in a social media network.

20. A computer-implemented method for assigning a score to a virtual point of interest included in a virtual world associated with a parallel reality game, the virtual world having a geography that parallels at least a portion of the geography of the real world such that the virtual point of interest parallels a real world point of interest, the method comprising:
collecting a plurality of signals indicative of a popularity associated with the real world point of interest, the popularity being defined with respect to one or more players of the parallel reality game; and
assigning a score to the virtual point of interest, the score being based upon the plurality of signals.

21. The computer-implemented method of claim 20, wherein the plurality of signals are further indicative of a level of online activity associated with the real world point of interest, the online activity being defined with respect to the one or more players of the parallel reality game.
